(19) United States
(12) Patent Application Publication
(10) Pub. No.: US 2024/0369440 A1
(43) Pub. Date: Nov. 7, 2024

(54) METHOD OF DETERMINING A LEAKAGE IN A HEAT TRANSFER FLUID CHANNEL OF A HEAT TRANSFERRING REACTOR SYSTEM, AND A HEAT TRANSFERRING REACTOR

(71) Applicant: Sumitomo SHI FW Energia Oy, Espoo (FI)

(72) Inventor: Teri Hiltunen, Leppävirta (FI)

(21) Appl. No.: 18/686,096

(22) PCT Filed: Sep. 9, 2022
(86) PCT No.: PCT/EP2022/075095

§ 371 Date: Feb. 23, 2024

(30) Foreign Application Priority Data
Sep. 9, 2021 (WO) PCT/EP2021/074841

(51) Int. Cl. G01M 3/26; B01J 8/18; G01M 3/00

(52) U.S. Cl. CPC G01M 3/26; B01J 8/1809; B01J 8/1836; G01M 3/002; B01J 2208/00088; B01J 2208/00097

(57) ABSTRACT

A method of determining a leakage in a heat transfer fluid channel of a heat transferring reactor system includes measuring the heat transfer fluid flow rate prevailing in the channel, modelling heat transfer heat transfer fluid flow rate in the channel during operation utilizing process data in a numerical model giving the fluid flow rate of the system under substantially leak-free conditions, comparing the measured fluid flow rate and modelled fluid flow rate to obtain an error measure for heat transfer fluid flow rate included in an error measure set, monitoring the error measure set and a number of occurrences, and determining the presence of a heat transfer fluid channel leakage in case the error measures exceed a pre-defined threshold, or a number of occurrences in the error measure set exceed a predetermined threshold during a predetermined time period.

### CROSS-REFERENCE TO PRIORITY APPLICATIONS

This application is a 35 U.S.C. § 371 National Stage patent application of international patent application no. PCT/EP2022/075095, filed Sep. 9, 2022, which claims priority to international patent application no. PCT/EP2021/074841, filed on Sep. 9, 2021.

### FIELD OF THE INVENTION

The invention relates to detection and assessment of leakages in a heat transfer fluid channel of a heat transferring reactor, in particular, a fluidized bed reactor, such as a circulating fluidized bed (CFB) reactor or a bubbling fluidized bed (BFB) reactor.

### TECHNICAL BACKGROUND

Combustion boilers, such as grate boilers and fluidized bed boilers are commonly utilized to generate steam that can be used for a variety of purposes, such as for producing electricity and heat.

In a fluidized bed boiler or gasifier, fuel and a hot bed of solid particulate bed material are introduced into a furnace and by introducing fluidizing gas from a bottom portion of the furnace to fluidize the bed material and fuel. Burning of fuel takes place in the fluidized bed. In bubbling fluidized bed reactors, fluidization gas is passed through the bed such that a major portion of the solid material stays in the bed.

In a circulating fluidized bed reactor CFB, fluidization gas is passed through the bed material. Most bed particles will be entrained in the fluidization gas and will be carried away with the flue gas. The particles are separated from the flue gas in at least one particle separator and circulated returning them back into the reactor chamber. It is common to arrange a fluidized bed heat exchanger downstream of the particle separator(s) to recover heat from the particles before they are returned into the furnace.

Generally, in a heat transferring reactor, a flow channel leakage causes a heat transfer heat transfer fluid to escape from the heat transfer fluid circuit, such that the escaped heat transfer fluid can enter a location of the reactor in an uncontrolled manner. A leakage can, in a worst case cause, a need for comprehensive repair of the reactor. Most of the leakage situations have much less severe consequences, at least if the leakage is detected reasonably fast.

A leakage in a flow channel generally requires shutting down the reactor, locating the leakage, and repairing or replacing of the tubes—or, generally, flow channels—for which the leakage had taken place. From the viewpoint of a plant operator, this can be a costly procedure. Not only so because of the expenditure caused by locating the leakage and then repairing or replacing of the tubes, but shutting down the reactor causes the reader to stop producing heat transfer fluid (which could be utilized to produce commercial commodities), the operator generally losing a source of income during the shutdown. In view of the costs resulting and the loss of heat transfer fluid production capability, it is important to avoid unnecessary shutdowns. The leakage detection should be performed reliably.

As an example of leak detection, a CFB boiler leakage detection system of the applicant is disclosed in Modern Power Systems (www.modernpowersystems.com) December 2018 article “Boiler Technology—SmartBoiler™: how the Internet of Things can improve boiler operating performance”. A boiler leakage detection module closely monitors furnace walls and other boiler heat exchange surfaces and, based on regression models using real process data and self-learning algorithms, predicts future problems so that maintenance could be planned in advance and restoration time be minimized.

### OBJECTIVE OF THE INVENTION

It is an objective to improve leakage detection in a heat transfer fluid channel of heat transferring reactor systems.

This objective can be achieved with the method with a heat transferring reactor according to the inventions related in the independent claims.

The dependent claims describe advantageous aspects of the method.

### ADVANTAGES OF THE INVENTION

A method for determining a leakage in a heat transfer fluid channel of a heat transferring reactor system comprises the steps of measuring the main heat transfer fluid flow rate Q_{MS,M} prevailing in the heat transfer fluid circuit of the heat transferring reactor system during operation, modelling main heat transfer fluid flow rate q_{MS,C} in the heat transfer fluid channel during operation by utilizing process data in a numerical model of the heat transferring reactor system giving the heat transfer fluid q_{MS,C} flow rate of the heat transferring reactor system under substantially leak-free conditions, comparing the measured heat transfer fluid flow rate and modelled heat transfer fluid flow rate with each other to obtain an error measure ΔMS for heat transfer fluid flow rate that is included in an error measure set, and monitoring the error measure set and characteristics of error measure set exceeding a predetermined threshold during a predetermined time period during operation to determining the presence of a heat transfer fluid circuit leakage.

With the method, it will be possible to improve leakage detection in a heat transfer fluid circuit of a heat transferring reactor system. Even though the heat transfer fluid flow rate may have large fluctuations between consecutive measurements, with a suitable numerical model of the heat transferring reactor system, the main heat transfer fluid flow rate can under substantially leak-free conditions, be computed numerically such rapidly that the error measure ΔMS will indicate with sufficient probability the presence of a tube leakage. In a heat transferring reactor, heat transfers devices and channels connecting them may be generally referred to as a fluid circuit.

Further, suitably preparing the characteristics monitoring, it will be possible to select the predetermined threshold such that (i) a sufficiently large (exceeding a pre-defined threshold, for example) error measures ΔMS will cause the determination of a heat transfer fluid circuit leakage faster than smaller error measures ΔMS, and (ii) also, the smaller error measures ΔMS will cause the determination of a heat transfer fluid circuit leakage if they persist for a pre-defined time (or number of measurements). This selection of the characteristics monitoring, and, in particular, the selected “boosting factor” approach used in the monitoring of error measure set and characteristics of error measure set, developed by the inventors, significantly contributes to the functioning of the method.

The “boosting factor” approach reflects the observation by the inventors that leakages in the heat transfer fluid circuit of a heat transferring reactor system may develop gradually, i.e., begin as small leaks. If unnoticed, a small leak may become a large leak within some time. In view of the large fluctuations or variance in the heat transfer fluid measurement, it has so far not been possible to reliably detect a small leak without using specific markers in the heat transfer fluid channel. Thus, it has been prone that leakages have been so far reliably detected only after the leak has become severe enough, which, however, tends to increase the effort needed to repair the heat transferring reactor system. With the present invention, the leakage detection reliability may be improved, thus helping to avoid false alarms (leading to unnecessary shutdowns and costly off-time of the heat transferring reactor system), but still being able to detect leakages fast.

The heat transfer fluid flow rate is preferably measured in the heat transfer fluid channel after a final or a last heat exchanger representing a final temperature of the heat transfer fluid.

The error measure ΔMS for a main heat transfer fluid flow rate is preferably the difference (ΔMS=q_{MS,MEASURED}−-q_{MS,COMPUTED}) between the measured heat transfer fluid flow rate (q_{MS,MEASURED}) with the computed heat transfer fluid flow rate (q_{MS,COMPUTED}).

Alternatively, the error measure ΔMS for a main heat transfer fluid flow rate may be the ratio between the measured heat transfer fluid flow rate (q_{MS,MEASURED}) and the computed heat transfer fluid flow rate (q_{MS,COMPUTED}).

These aspects may be combined such that the error measure ΔMS for main heat transfer fluid flow rate may be a difference (ΔMS=q_{MS,MEASURED}−q_{MS,COMPUTED}) between the measured heat transfer fluid flow rate (q_{MS,MEASURED}) with the computed heat transfer fluid flow rate (q_{MS,COMPUTED}), and/or a ratio between the measured heat transfer fluid flow rate (q_{MS,MEASURED}) and the computed heat transfer fluid flow rate (q_{MS,COMPUTED}).

The method may further comprise, when using the method in a heat transfer fluid channel, or a circuit of a heat transferring reactor, the steps of measuring at least one process parameter prevailing in at least one location of the reaction chamber of the reactor system, modelling at least one of corresponding process parameters during operation of the reactor system by utilizing process data in a numerical model, giving the corresponding process parameter of the reactor system under substantially leak-free conditions, and comparing the at least one measured process parameters and the corresponding at least one modelled process parameters with each other to obtain an error measure for the at least one process parameters also included in the error measure set.

With this approach, the measurements in the reaction chamber can be deployed to improve the accuracy of the method, and/or, also, to include detection of the reactor system component in which the leakage is present. Most conveniently, the process parameters comprise at least one of the following: temperature and/or pressure.

Error measure for the at least one process reaction chamber parameter may be a difference between the measured process parameter and a modeled process parameter.

Alternatively, error measure for the at least one process reaction chamber parameter may be a ratio between the measured process parameter and the modeled process parameter.

These may be combined, such that error measure for the at least one process reaction chamber parameter may be a difference between the measured process parameter and modeled process parameter and/or a ratio between the measured process parameter and modeled process parameter.

According to an embodiment of the invention, the characteristics of error measure set may comprise a number of occurrences exceeding a predetermined threshold during a predetermined time period during operation.

An embodiment of the invention is a circulating fluidized bed (CFB) reactor system, but the invention also can be realized, among other kinds of systems.

In the case of a CFB reactor system, the process parameter measured in at least one location of the inside preferably includes a pressure in a loop seal arranged downstream a particle separator in return leg, or, in other words, a return channel, which return leg is arranged for returning separated particles into a reaction chamber.

In this situation, preferably, the method comprises monitoring a number of occurrences of error measure for a main heat transfer fluid flow rate exceeding predetermined threshold, which number of exceeding occurrences is included in the characteristics of error measure, and the method further comprises monitoring a number of occurrences of error measure for pressure in the loop seal exceeding predetermined threshold, which number of exceeding occurrences is included in the characteristics of error measure. A heat transfer fluid circuit leakage may then be determined to be in the loop seal (i) if the error measure for heat transfer fluid flow rate and the number of occurrences of error measure for main heat transfer fluid flow rate exceed the predetermined threshold and further (ii) if an error measure related to pressure in the loop seal and the number of occurrences of pressure in the loop seal parameters in the loop seal exceed the predetermined threshold.

In the case of a CFB reactor system, the process parameter measured in at least one location inside the reactor preferably includes or consists of a product gas temperature at an exit of a particle separator.

In this situation, preferably, a leakage is determined to be in the particle separator (i) if the error measure for a main heat transfer fluid flow rate and the number of occurrences of error measure for main heat transfer fluid flow rate both exceed, respectively, the predetermined threshold for corresponding error measures, and further (ii) if an error measure related to product gas temperature at the exit of the particle separator and the number of occurrences of product gas temperature at the exit of particle separator both exceed, respectively, a predetermined threshold for the product gas temperature error measures.

In the case of a CFB reactor system, the process parameter measured in at least one location inside the reactor preferably includes or consists of bed temperature in a fluidized bed heat exchanger that comprises a heat exchanger.

Common for all aspects and embodiments of the method is that the characteristics of error measure may include the number of respective occurrences exceeding a predetermined threshold.

The heat transferring reactor system comprises a local control system and/or is connected to a remote control system, the control system(s) configured to carry out the leakage determination method. The heat transferring reactor system further comprises a display/monitor for displaying to the operator the presence of tube leakage detected using the method.

### BRIEF DESCRIPTION OF THE DRAWINGS

In the following, the method and the reactor system are explained in more detail with reference to the exemplary embodiments disclosed in the appended drawings of which:

FIG. 1 illustrates a circulating fluidized bed (CFB) reactor system;

FIG. 2 illustrates a bubbling fluidized bed (BFB) reactor system;

FIG. 3 illustrates a calibration method for the numerical model in a CFB reactor system;

FIG. 4 illustrates a possibility for training of the mathematical model and data usage;

FIG. 5 illustrates the calculation of leakage risk; and

FIG. 6A to 6I show selected data of a test in which the method was applied on real CFB boiler system data to verify the functioning of the method.

The same reference numerals refer to same technical features in all drawings.

### DETAILED DESCRIPTION

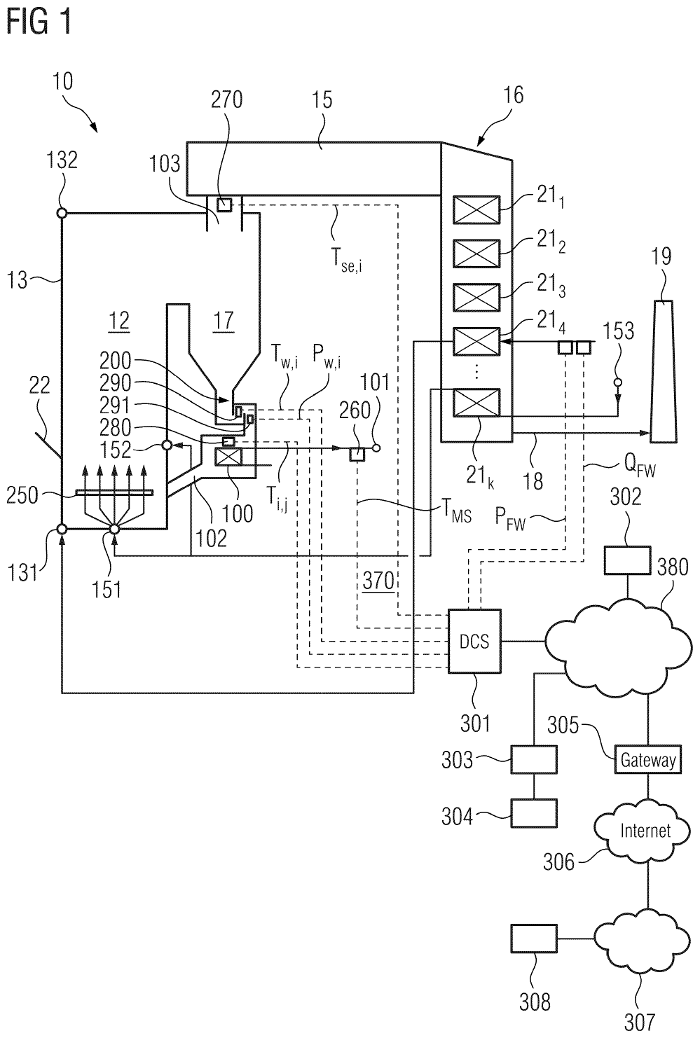

FIG. 1 shows a heat transferring reactor system 10. More particularly, FIG. 1 discloses a circulating fluidized bed (CFB) boiler in which heat is produced by combustion of fuel, and the heat is transferred to a heat transfer fluid (water-steam). The reactor 10 comprises a wall and various heat exchangers in which heat transfer fluid (water-steam) is arranged to flow so as to receive heat obtained from the combustion of fuel, and, thus, a CFB boiler is an example of a heat transferring reactor. The reactor comprises a reactor space 12, specifically, a furnace 12 that has tube walls 13 (typically, comprising a front wall, a rear wall, side walls) connected to a heat transfer fluid (water-steam) circuit of the combustion boiler system 10. FIG. 1 illustrates a once-through steam generator case where water is fed from a feed water tank 50 to evaporator (walls of furnace) and then guided via superheaters to a turbine (not shown in the figures). A flue gas channel may be provided with an economizer and/or superheater/s.

Fluidization gas (such as, air and/or oxygen-containing gas) is fed from fluidization gas supply 153 to the reactor via primary fluidization gas feed 151, usually, such that the primary fluidization gas enters the reactor space through nozzles at the grid 250 for fluidizing the bed material, and secondary gas feed 152 to feed gas to control reaction in the reactor). The effect is that the bed materials will be fluidized and, also, gases required for the reactions are provided into the reactor 12. Further, fuel, or other reactant is fed into the reactor chamber 12 via the feed inlet 22.

The reaction in the chamber can be adjusted by controlling the reactant feed 22 by reducing or increasing the feed rate, and by controlling the fluidization gas feed by reducing or increasing the flow rate of the gas into the reactor chamber 12. Particularly, when the reactor is used for combustion of fuel, the fuel can be fed together with additives, in particular, with such additives that act as alkali sorbents, such as CaCO₃ and/or clay, for example. In addition, or alternatively, NOₓ reduction agents, such as ammonium or urea can be fed into the combustion zone of the furnace 12, or above the combustion zone of the furnace 12.

Bed material may also be fed into and removed from the reactor, which bed material may comprise, depending on the practical application, sand, limestone, and/or clay, that, in particular, may comprise kaolin, as well as oxide of alkali metals, such as CaO. One effect of the bed and, generally, of the combustion, is that, in the heat transfer, fluid is heated more efficiently, when the heat surface is in interaction with a fluidized bed.

So called bottom ash (or any particles which may not be fluidized) may fall to the bottom of the reactor 12 and be removed via a chute (omitted from FIG. 1 for the sake of clarity) and part of the solid material, particularly, lighter particles, will be carried along with product gas.

Reaction products, such as product gas and lighter particles proceed from the reactor 12 to a particle separator 17 that may comprise a vortex finder 103. The particle separator 17 separates solid particles from product gases. The product gas may differ depending on the reactions taken place in the reactor system 10.

When the reactor is a CFB boiler, combustion products, such as flue gas, unburnt fuel, and bed material proceed from the furnace 12 to a particle separator 17 that may comprise a vortex finder 103. The particle separator 17 separates flue gases from solids. Especially, in larger combustion boilers 10, there may be more than one (two, three, . . . ) separators 17, preferably, arranged in parallel to each other.

Solids separated by the separator 17 pass through a loop seal 200 that preferably is located at the bottom of the separator 17. Then, the solids may pass to fluidized bed heat exchanger (FBHE) 100 that also includes a heat transfer surface (such as, but not limited, comprising tubes and/or heat transfer panels) so that the FBHE 100 receives heat from the solids to further heat the heat transfer fluid in the heat transfer fluid circuit.

The FBHE 100 may be fluidized and comprise heat transfer tubes or other kinds of heat transfer surfaces and be arranged as a reheater or as a superheater. The solids may exit the FBHE 100 via return channel 102 back into the reactor 12.

The products gases, which are, in a combustion process, referred to as flue gases, are passed from the separator 17 to crossover duct 15 and from there further to back pass 16 (that preferably may be a vertical pass) and from there via gas duct 18 to stack 19. In case the product gas is utilized in another way, the gas is collected and led to further processing.

The back pass 16 comprises a number of heat transfer surfaces 21i (where i=1, 2, 3, . . . , k, where k is the number of heat transfer surfaces). In FIG. 1, of the heat transfer surfaces, heat transfer surfaces 21₁, 21₂, 21₃, 21₄ 21ₖ are illustrated. The actual number of different heat transfer surfaces in each of these components, for example, may be selected for each combustion boiler differently according to actual needs. And, there may be further components as well, comprising a heat transfer surface 21. Heat transfers devices and channels connecting them may be generally referred to as a fluid circuit.

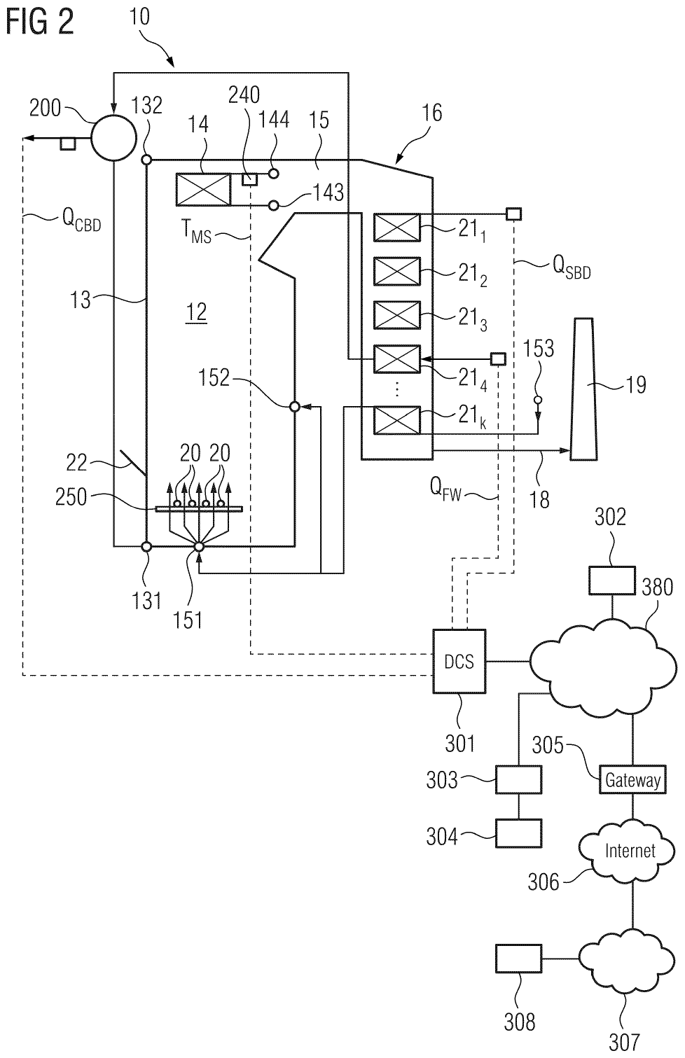

A heat transferring reactor system 10 is equipped with a plurality of sensors and computer units. FIG. 1 and FIG. 2 illustrate some of the sensors and computer units. Examples of sensors are heat transfer fluid flow rate sensor 260 measuring the heat transfer fluid temperature at the outlet 101 of the FBHE 100, temperature sensor 280 measuring bed temperature at the FBHE 100 chamber, temperature sensor 270 measuring the product gas exit temperature at the separator 17, the temperature sensor 290 measuring the temperature in the loop seal 200, and/or the pressure sensor 291 measuring the pressure in the loop seal 200. The FBHE may be provided with a pressure sensor for measuring pressure at the FBHE chamber. In the embodiment shown in FIG. 1 FBHE 100 is the last heat exchanger wherefrom heat transfer fluid is led to further processing via the FBHE outlet 101. The last heat exchanger in the heat transfer fluid channel can be positioned to other location in the reactor system 10 if so desired.

Process data may be collected from the sensors by distributed control system (DCS) 301. The data collection may most conveniently be arranged over a field bus 370, for example. DCS 301 may have a display/monitor 302 for displaying operational status information to the operator. An EDGE server 303 may process measurement data from the obtained from sensors, such as, a filter and smooth the data. There may be a local storage 304 for storing data.

The DCS 301, display/monitor 302, EDGE server 303, and local storage 304 may be in a reactor network 380 (local storage 304 preferably directly connected to the EDGE server 303). The reactor network 380 is preferably separate from the field bus 370 that is used to communicate measurement results from the sensors to the DCS 301 and/or the EDGE server 303. Between the DCS 301 and EDGE server 303, there may be an open platform communications server to make the systems better interoperable.

Reactor network 380 may be in connection with the internet 306, preferably, via a gateway 305. In this situation, measurement results may be transferred from the reactor network 380 to a cloud service, such as to process intelligence system 308 located in a computation cloud 207. The applicant currently operates a cloud service running an analysis platform. The cloud service may be operated on a virtualized server environment, such as on Microsoft® Azure®, which is a virtualized, easily scalable environment for distributed computing and cloud storage for data. Other cloud computing services may be suitable for running the analysis platform too. Further, instead of a cloud computing service, or in addition thereto, a local or a remote server can be used for running the analysis platform.

FIG. 2 illustrates a reactor system 10 that may be a bubbling fluidized bed BFB reactor. A BFB reactor differs from a CFB reactor in that the fluidization velocity is less than that in CFB. Thus, there may be no need for the separator 17, loop seal 160, FBHE 100, and return channel 102.

There may be at least one heat exchanger 14 located in the reactor chamber 12, preferably, on the upper part of the chamber 12. Temperature sensor 240 measures the temperature at the heat exchanger outlet 144. Specifically, the heat transfer fluid flow rate sensor 240 measures the heat transfer fluid flow rate at the heat exchanger outlet 144, which heat exchanger is the last heat exchanger in the reactor system 10, wherefrom heat transfer fluid will be guided to further processing.

The method of determining a leakage in a heat transfer fluid circuit of a heat transferring reactor system comprises the steps of measuring the heat transfer fluid flow rate q_{MS,M} prevailing in the heat transfer fluid circuit of the reactor system during operation, modelling heat transfer fluid flow rate q_{MS,C} in the heat transfer fluid circuit during operation by utilizing process data in a numerical model of the reactor system giving the heat transfer fluid flow rate q_{MS,C} of the reactor system 10 under substantially leak-free conditions, comparing the measured heat transfer fluid flow rate and modelled heat transfer fluid flow rate with each other to obtain an error measure D_{MS} for heat transfer fluid flow rate that is included in an error measure set, and monitoring the error measure set and characteristics of error measure set exceeding a predetermined threshold during a predetermined time period during operation to determining the presence of a heat transfer fluid circuit tube leakage.

The method may further comprise the steps of measuring at least one process parameter prevailing in at least one location of inside of the reactor system, modelling at least one of corresponding process parameters during operation of the heat transferring reactor system by utilizing process data in a numerical model, giving the corresponding process parameter of the reactor system 10 under substantially leak-free conditions, and comparing the at least one measured process parameter and the corresponding at least one modelled process parameter with each other to obtain an error measure for the at least one process parameters also included in the error measure set.

The process parameter may comprise or consist of at least one of the following: temperature and/or pressure.

CFB reactor, Loop seal 290: The process parameter may include or consist of a pressure in a loop seal 290 arranged downstream a particle separator 17 in return leg, which return leg is arranged for returning separated particles into a reactor chamber 12. Then, the method preferably comprises monitoring a number of occurrences of error measure for main heat transfer fluid flow rate exceeding predetermined threshold. The number of exceeding occurrences is included in the characteristics of error measure. The method further comprises monitoring a number of occurrences of error measure for pressure in the loop seal exceeding a predetermined threshold, which number of exceeding occurrences is included in the characteristics of error measure. A heat transfer fluid circuit leakage is determined to be in the loop seal if the error measure for main heat transfer fluid flow rate and the number of occurrences of error measure for main heat transfer fluid flow rate exceed the predetermined threshold and, further, if an error measure related to pressure in the loop seal and the number of occurrences of pressure in the loop seal parameters in the loop seal exceed the predetermined threshold.

CFB reactor, Separator 17: The process parameters may include or consist of a product gas temperature at an exit of a particle separator. Then, preferably, a leakage is determined to be in the particle separator if the error measure for heat transfer fluid flow rate and the number of occurrences of error measure for heat transfer fluid flow rate both exceed, respectively, the predetermined threshold for corresponding error measures and, further, if an error measure related to product gas temperature at the exit of the particle separator and the number of occurrences of flue gas temperature at the exit of particle separator both exceed, respectively, a predetermined threshold for the product gas temperature error measures.

FBHE 100: The process parameters may include or consist of bed temperature in a heat transfer fluidized bed heat exchanger that comprises heat exchange surfaces.

Steam generation process, superheater 14: The process parameters may include or consist of bed temperature of a BFB boiler system that is a fluidized bed heat exchanger comprising superheater heat transfer surfaces.

A leakage may be determined at the fluidized bed heat exchanger 100 operating as a steam reheater connected between turbine stages, if an error measure of bed temperature of the fluidized bed heat exchanger and the number of occurrences of error measure both exceed, respectively, a predetermined threshold, preferably, not requiring the error measure for main steam (heat transfer fluid) flow rate to exceed the respective threshold since the reheater is located after the heat transfer fluid circuit.

Common for all embodiments is that the characteristics of error measure may include or consist of the number of respective occurrences exceeding a predetermined threshold.

Common for all embodiments is that the exceeding is tested within the evaluation time window. This may be s suitably selected time interval, such as, for last sixty minutes.

As explained above, the heat transferring reactor system 10 comprises a local control system 301, 303 and/or is connected to a remote-control system 308. The control system(s) is/are configured to carry out the leakage determination method. The reactor system 10 comprises a display/monitor 302 for displaying to the boiler operator the presence of tube leakage detected using the method.

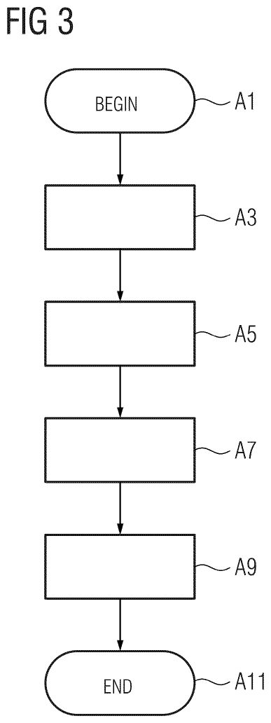

FIG. 3 illustrates an example of the model building or calibration process.

After initiation in the beginning of the model building or calibration (step A1), in step A3, the numerical model for/heat transfer fluid balance in the reactor system 10 is constructed, such as by regression modelling. Depending on the type of the reactor system 10, the model may be different, such as:
In a steam boiler, an equation for water/steam balance, for a drum boiler:

$${q}_{ms , c} = {a}_{0} + {a}_{1} {q}_{fw} + {a}_{2} Dt ( {q}_{fw} ) + {a}_{3} {q}_{cbd} + {a}_{4} {q}_{sbd} + {a}_{5} Dt ( DL ) ,$$

where:
   q_{ms,c}=modelled main steam flow rate,
   q_{fw}=feed water flow rate, may be measured, e.g., before an economizer,
   Dt(q_{fw})=Dt(feed water flow rate) is a time derivative of feed water flow rate (how feed water flow changes in a certain time),
   q_{cbd}=continuous blow down flow from steam, water discharged from the drum,
   q_{sbd}=soot blow steam flow may be steam from superheater path before a final superheater,
   Dt(DL)=Dt(drum level) is a time derivative of drum level (how drum level changes in certain time), and
a₀, a₁ . . . a₅=Calibration coefficients determined by linear regression method.

Alternatively, a modeled main steam flow may be obtained using an artificial intelligence tools and/or a neural network.

An equation for a water/steam balance once through a boiler:

$${q}_{m s , c} = {a}_{0} + {a}_{1} {q}_{fw} + {a}_{2} DT ( {q}_{fw} ) + {a}_{3} {p}_{fw} + {a}_{4} Dt ( {p}_{fw} ) ,$$

where:
   q_{ms,c}=modelled main steam flow,
   q_{fw}=feed water flow,
   Dt(q_{fw})=Dt(feed water flow),
   p_{fw}=feed water pressure,
   Dt(p_{fw})=Dt(feed water pressure), and
ₐ₀, a₁, . . . , a₄=calibration coefficients determined by a linear regression method.

Alternatively, a modeled main steam flow rate may be obtained using artificial intelligence tools and/or a neural network.

In step A5, for each FBHE 100ᵢ, a numerical model for the temperature calculation of the FBHEᵢ is constructed, such as by regression modelling:
An equation for FBHEᵢ bed temperature calculation:

$${T}_{i , j , c} = {b}_{0} + {b}_{1} {T}_{w , i} + {b}_{2} {T}_{se , i} + {b}_{3} {q}_{ms , m} + {b}_{4} Dt ( {q}_{ms , m} ) ,$$

where:
   Tᵢⱼ=modelled bed temperatures of FBHE 100ᵢ. (number of temperature points is N so that, j=1, . . . , N),
   T_{w,i}=loop seal 200i temperature,
   T_{se,i}=flue gas exit temperature of separator 17i.
   q_{ms,s}=main steam flow,
   Dt(q_{ms,m})=Dt(main steam flow), and
b₀, b₁ . . . b₄=coefficients determined by a linear regression method.

Alternatively, a modeled bed temperature may be obtained using artificial intelligence tools and/or a neural network.

In step A7, for each separator 17ᵢ, a numerical model for the temperature calculation of the separator 17ᵢ is constructed, such as by regression modelling:
An equation for Separatorᵢ temperature calculation:

$${T}_{separator exit , i , c} = {c}_{0} + {c}_{1} {T}_{inlet , i} + {c}_{2} {T}_{msei} ,$$

where:
   T_{separator exit,i,c}=modelled separator 17ᵢ flue gas exit temperature,
   Tₘₛₑᵢ=mean of other separator 17j (computed for all other separators 17ⱼ, except separatorᵢ, i.e. j¹i),
   T_{separator, inlet, i}=separator 17ᵢ inlet temperature, and
c₀, c₁ . . . c₂=coefficients determined by a linear regression method.

Alternatively, a modeled separator flue gas exit temperature may be obtained using artificial intelligence tools and/or a neural network.

In step A9, for each loop seal 200ᵢ, a numerical model for the pressure at the loop seal 200ᵢ is constructed, such as by regression modelling:
An equation for loop seal 200ᵢ pressure calculation:

$${p}_{ws , I , C} = {d}_{0} + {d}_{1} {p}_{mwsi} ,$$

where:
   p_{wsi.C}=Modelled loop seal; pressure,
   p_{mwsj}=mean of other loop seal pressure (computed for all other loop seals 200ⱼ. except loop seal 200ᵢ, i.e. j¹i), and
d₀, d₁=Factor determined by linear regression method.

Alternatively, a modeled bed loop seal pressure may be obtained using artificial intelligence tools and/or a neural network.

Generally, a numerical model for a process parameter in the reactor system 10 is constructed, such as by regression modelling. Depending on the type of the reactor system 10, the model may be different, such as a mass balance for at least main process parameters that characterize the run of the process. For example, the bed pressure value and its normal fluctuations in space and time are very different in, e.g., a CFB bed inside the reactor or a BFB bed connected to the CFB reactor, such as a BFB heat exchanger. Also, an independent BFB reactor bed behaves differently to CFB reactor bed both having individual characteristics.

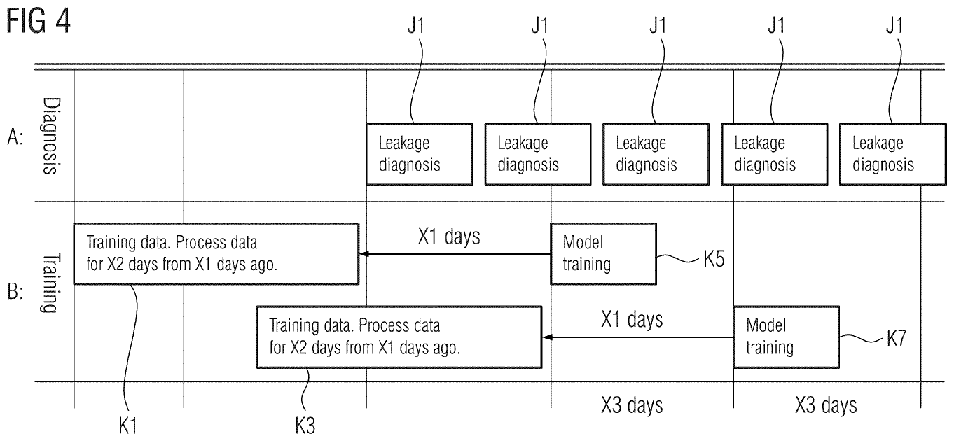

FIG. 4 illustrates the operation of the leakage detection system in which diagnosis (A) and training, i.e., building or calibration of model (B) are separated. In the diagnosis block (A), leakage diagnosis method J1, according to the invention, is preferably executed at predefined time intervals or periodically, such as, once a minute.

In the training block (B), there are at least two separate sets of training data, which are used for training of the model. First training data set K1 comprises process data for X2 days (data acquired during a period of X2 days) from X1 days ago from day of running the model training procedure. Second training data set K3 also comprises process data for X2 days from X1 days ago from the day of running the model training procedure. The starting and/or ending time for the training procedures using the first training data set K1 and the second training dataset K3 are different (the difference denoted as X3 days). The training data sets K1, K3 may partially overlap, or they may be so separated that they do not overlap.

The model training K5 (cf. FIG. 3) using first data set K1 may be invoked at predefined intervals or periodically, such as, every X1 days. Similarly, the second model training K7 (cf. FIG. 3) using the second data set K3 may be invoked after the predefined interval (X3 days has passed) from running the first model training K5.

The purpose of this practice is that, should there be a leakage in the heat transfer fluid circuit of the reactor system 10, the leakage would corrupt the calibration data. Running the model training intermittently using different training data at different time, makes it possible to detect a possible leak before the data is used for modelling and, thus, disregards such corrupted data. Since some leakages develop slowly, this is believed to improve the reliability of the detection algorithm.

Examples of the use of models:
Model output is modelled values compared to measured values such as:
Water/steam balance:

$$DMS = {q}_{ms}^{′} - {q}_{ms} ,$$

q′ₘₛ=modelled main steam flow rate,
qₘₛ=measured main steam flow rate,
DMS<DMSₗᵢₘᵢₜ in normal process state, and
DMSₗᵢₘᵢₜ=process−/model−or reactor−dependent value.

Separator 17ᵢ (where i=1, 2, . . . N, where N is the number of separators 17ᵢ in a combustion boiler system 10):

$${Dse}_{i} = {T}_{se , i}^{′} - {T}_{se , i} ,$$

T′_{se,i}=Modelled separator 17ᵢ flue gas exit temperature,
T_{se,i}=Measured separator 17ᵢ flue gas exit temperature,
Dseᵢ<Dseₗᵢₘᵢₜ in normal process state for separators, and
Dseₗᵢₘᵢₜ=process/model/boiler dependent value.

Fluidized bed heat exchanger FBHE 100:

$${DT}_{i 1 … n} = {T}_{i 1 … n}^{′} - {T}_{i 1 … n}^{′} ,$$

T′_{i1 . . . n}=Modelled bed temperatures 1 . . . n of FBHE 100ᵢ,
T_{i1 . . . n}=Measured bed temperatures 1 . . . n of FBHE 100ᵢ,
DT_{i1 . . . n}<DTₗᵢₘᵢₜ in normal process state for an FBHE, and
DTₗᵢₘᵢₜ=process/model/boiler dependent value.

Loop seal 200ᵢ (where i=1, 2, . . . N, where N is the number of loop seals 200ᵢ in a combustion boiler system 10):

$${Dp}_{i} = {p}_{ws , i}^{′} - {p}_{ws , i} ,$$

p′_{ws,i}=modelled loop seal 200ᵢ pressure,
P_{se,i}=measured loop seal 200ᵢ pressure,
Dpᵢ<Dpₗᵢₘᵢₜ in normal process state for separators, and
Dpₗᵢₘᵢₜ =process/model/boiler dependent value.

Superheater 14:

$${DT}_{sh} = {T}_{SH}^{′} - {T}_{SH} ,$$

T′_{SH}=Modelled temperature of superheater 14,
T_{SH}=Measured temperature of superheater 14,
DT_{SH}<DT_{SH,limit} in normal process state for superheater 14, and
DT_{SH,limit}=process/model/boiler dependent value.

Generally, a reactor-and/or a process-dependent process parameter X is selected that is affected by a leak in a fluid channel. The process parameter is modelled, and modelled values are compared to measured value of the process parameter. A difference DX=X′(modelled value)−X (measured value) is used to evaluate the leakage status such that there is a normal condition if DX<DXₗᵢₘᵢₜ, DXₗᵢₘᵢₜ being a limit value for allowed value of the difference for parameter X.

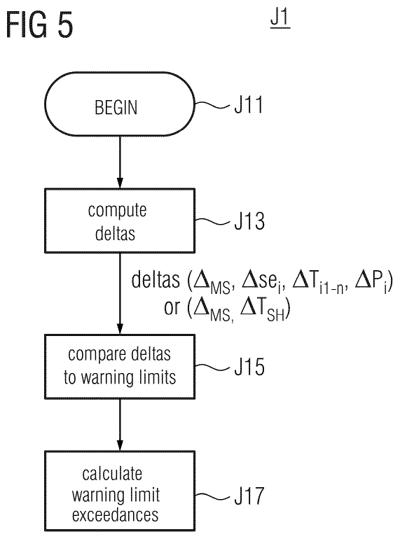

FIG. 5 illustrates the leakage diagnosis step (J1 in FIG. 4), in more detail, the calculation of tube leakage risk.

In step J13, the deltas (difference between modelled and measured value) are computed.

Initially, in CFB boiler system DMS, and optionally Dseᵢ and/or DT_{i1 . . . n} and/or Dpᵢ (and, respectively, in BFB boiler system DMS and optionally also DTₛₕ) may calculated for a predefined time interval, such as for last sixty minutes.

In the next step, J15, the deltas are compared to the respective warning limits. A warning limit was set for each model as a constant and when a delta is below the respective warning limit, process is on a normal state. Then, diagnosis calculates in step J17 warning limit exceedances. In the case of a multi-model like FBHE 100ᵢ, a component is set as abnormal, if the component exceeds the respective process/model/boiler dependent value, such as when DT_{i1 . . . n}>X.

Tube leakage risk level may be calculated using equations (internal value):

$$If {n}_{e} ⋆ BF > {t}_{u} :$$

$$R = 100 + ( {n}_{e} ⋆ BF - {t}_{u} ) / {t}_{r} ⋆ 100$$

$$else :$$

$${R}_{C} = ( {n}_{e} ⋆ BF - {t}_{1} ) / ( {t}_{u} - {t}_{1} ) ⋆ 100 ,$$

where:
R_{C}=Leakage risk level of component (location) or water/steam balance,
nₑ=Number of exceedances in reference period,
tᵣ=Length of reference period (minutes),
t₁=Lower limit,
tᵤ=Upper limit,
BF1=Boost factor, and

$$B F = 1 + ( {E}_{s} / ( WL ⋆ N ) - 1 ) ⋆ B$$

where:
BF=Boosting factor,
B=Boosting slope,
WL=Warning limit for err,
N=number of exceedances, and
Eₛ=sum (err), when err>Warning limit.

A leakage index may be calculated using equations:

$${I}_{c} = {R}_{c} , if {R}_{c} < 100 ; {I}_{c} = 100 , if {R}_{c} > 100$$

where:
I_{c}=Component leakage index (location) or water/steam balance index, and
R_{c}=Leakage risk level component (location) or water/steam balance.

If the leakage index is greater or equal to fifty but below one hundred, a “yellow” warning issues for location or water/steam balance.

If leakage index is greater than one hundred, a “red” warning issues for location or water/steam balance.

Overall leakage index:

$$if {I}_{c m} < 50 :$$

$$I = {R}_{ws} / 2 ,$$

$$if {I}_{c m} > = 50 : , and$$

$$I = {R}_{ws} / 2 + {I}_{cm} / 2 ,$$

where:
I=overall leakage index,
R_{ws}=Leakage risk level of water/steam balance, and

I_{cm}=Maximum component leakage index.

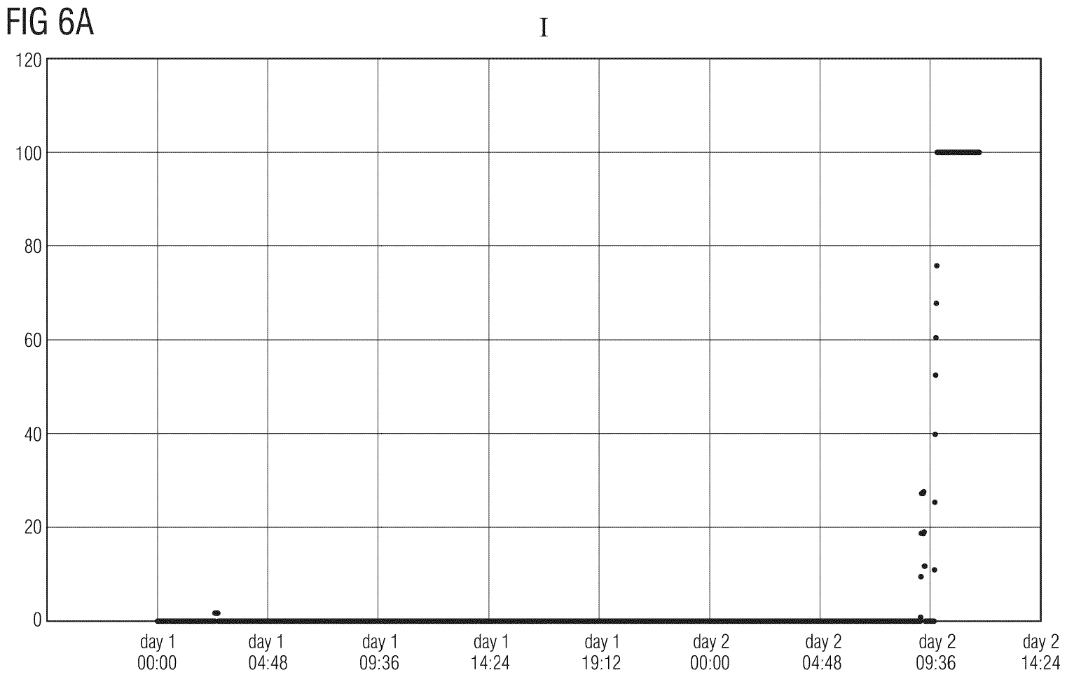

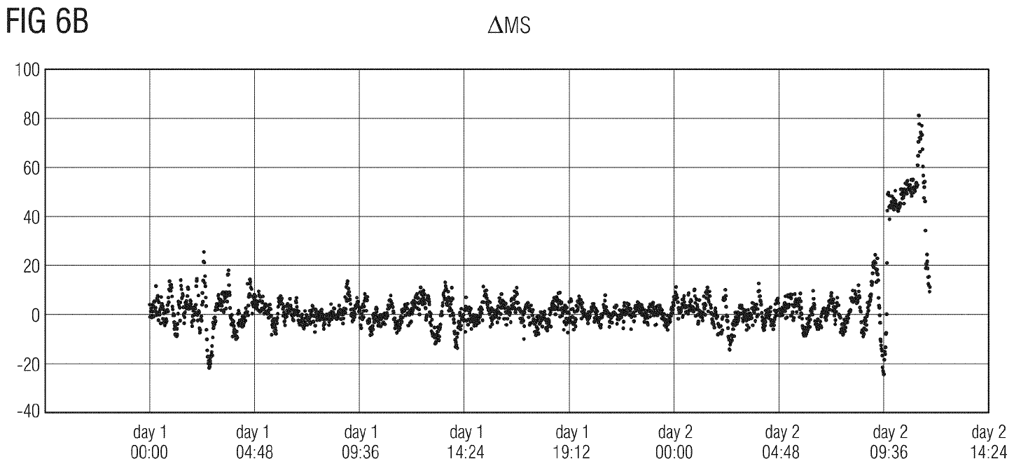

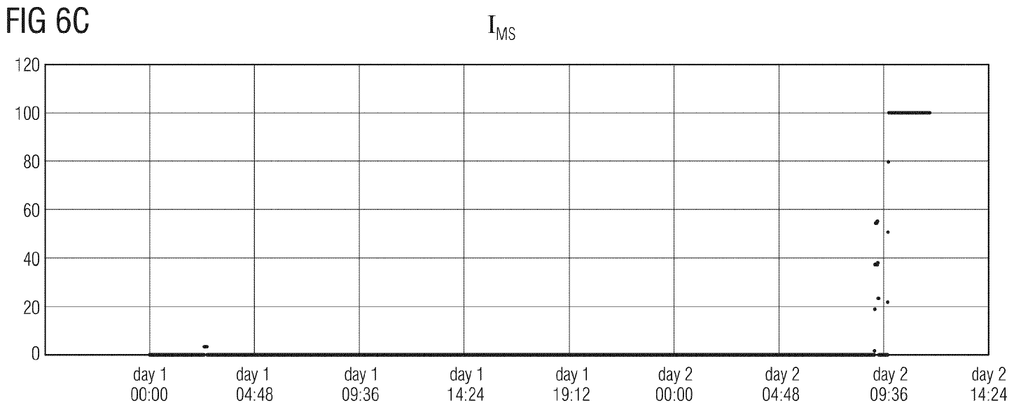

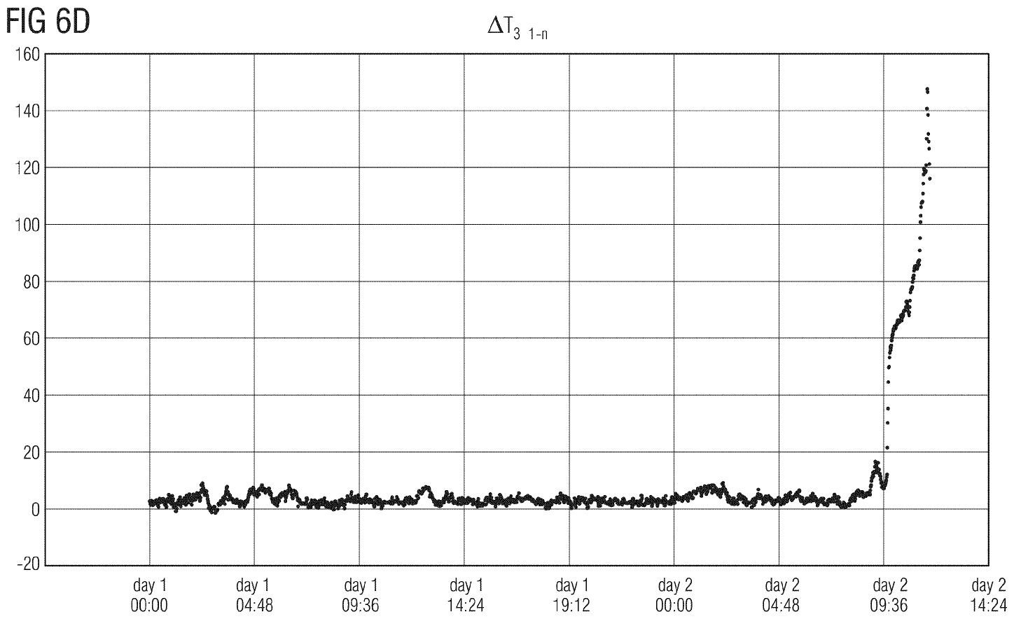

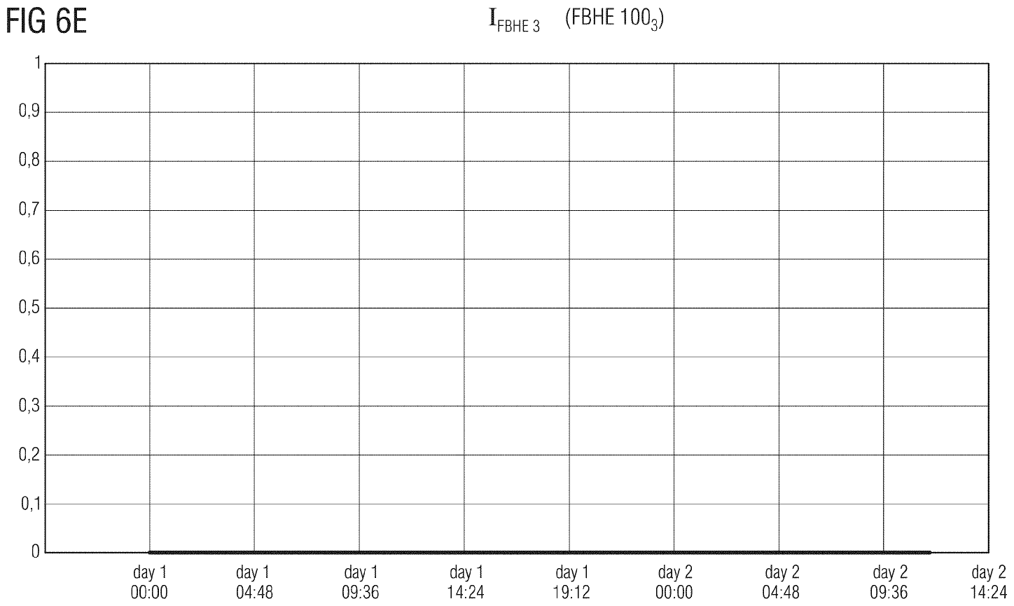

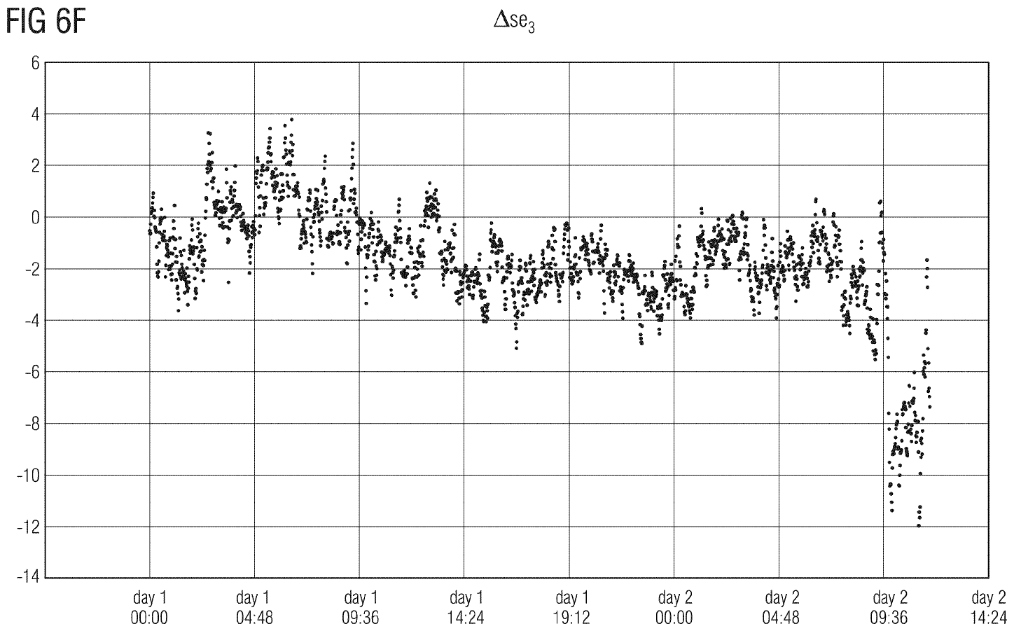

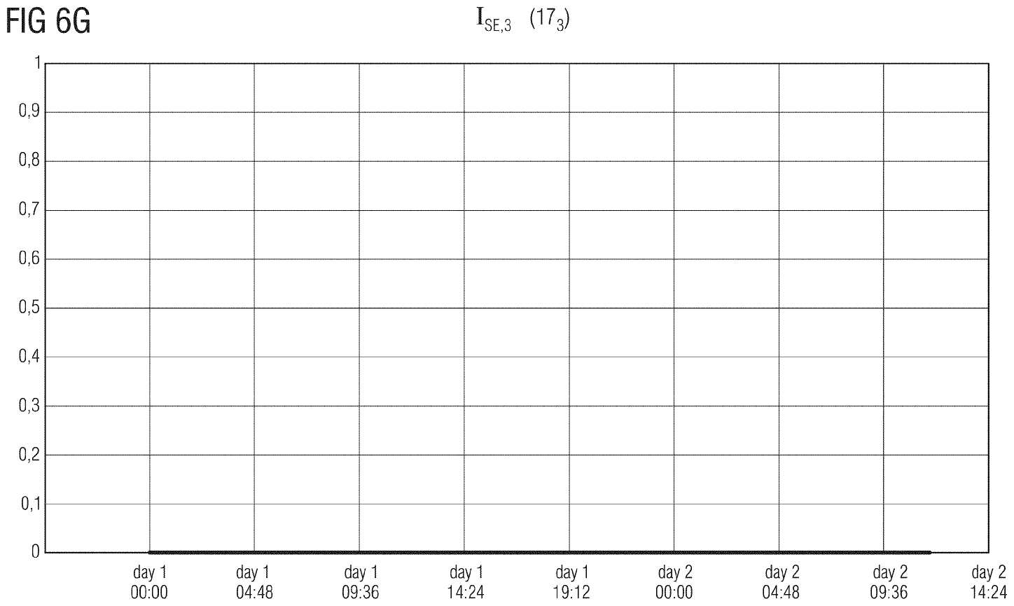

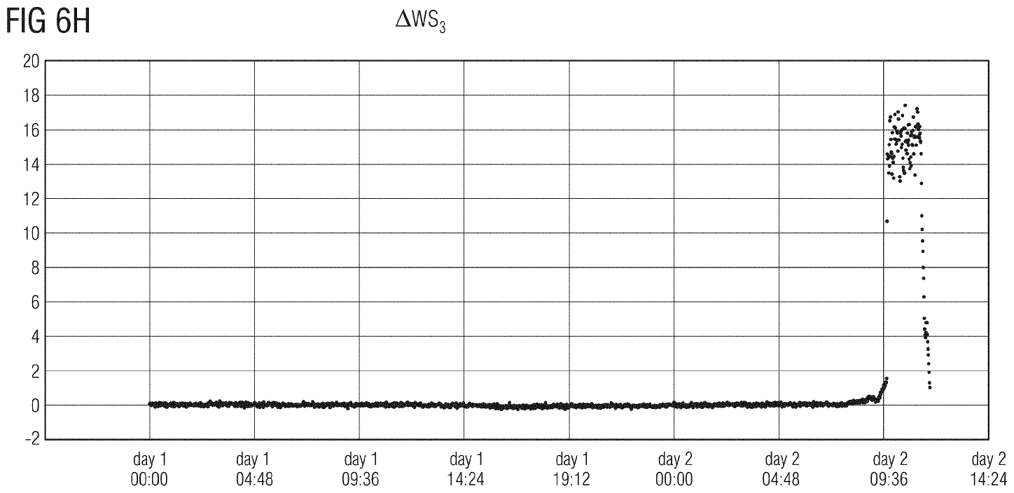

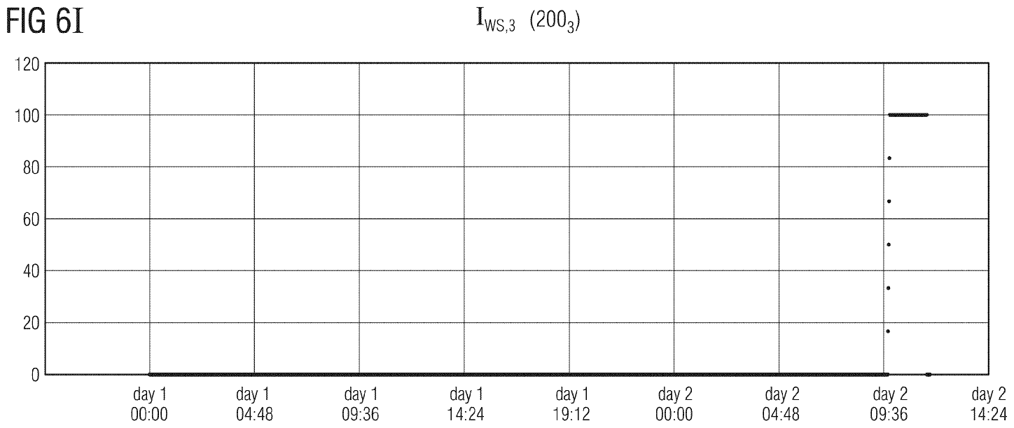

The present inventors have validated the functioning of the method on real data collected from a CFB combustion boiler system that was stored. The data is disclosed in FIG. 6A to 6I and shows (as could be understood to simulate a DCS 301, EDGE system, possibly, with participation of a remote process intelligence system 308, and displayed on display/monitor 302 to the boiler operator) in an exemplary fashion how the method can be used to indicate to the boiler operator a presence of a tube leakage in water-steam circuit of a combustion boiler system.

FIG. 6A shows the so computed overall leakage index I, computed as explained above, for a test period. As it can be seen, the index reaches one hundred at a rightmost time period column. There is a boiler leak present. In the actual situation when the process data is collected from the boiler was shut down.

FIG. 6B shows the delta in water/steam balance, i.e., DMS computed of the same combustion boiler system 10 process data. The rather large fluctuations can be seen. There is a significant increase on at the rightmost time period column. FIG. 6C shows the leakage index I_{MS} computed only for water/steam balance.

FIG. 6D shows the delta for FBHE 1003, i.e., DT_{3 1-n} computed of the same combustion boiler system 10 process data. The increase of the delta is rather slow. FIG. 6E shows the leakage index I_{FBHE 3}, i.e., leakage index computed only for component FBHE 100₃.

FIG. 6F shows the delta for separator 17₃, i.e., Dse₃ computed of the same combustion boiler system 10 process data. FIG. 6G shows the leakage index I_{SE,3}, i.e., leakage index computed only for component separator 17₃.

FIG. 6H shows the delta for loop seal 200₃, i.e., Dws₃ computed of the same combustion boiler system 10 process data. FIG. 6I shows the leakage index I_{WS,3}, i.e., leakage index computed only for component loop seal 200₃.

From the overall leakage index I, the presence of a tube leakage in the water-steam circuit of combustion boiler system 10 can be detected reliable and possibly also sooner than in the previous realizations of the combustion boiler systems of the present applicant.

From the component-specific leakage indexes that are preferably computed for all leakage-prone components of the combustion boiler system 10 (in this example, leakage indexes for each FBHE 100ᵢ, for each separator 17ᵢ, and for each loop seal 200ᵢ), the location in which component the tube leakage is present can be detected reliable.

In other words, in the leakage detection method according to the first aspect of the present invention, a risk level is computed using a time series of measures between model-based quantities estimated for the actual bed situation using determined fluidized bed combustion boiler operating parameters and the respective quantities computed from measurements, such that measures account to the risk level in an over-proportional manner respective to their magnitude. The risk level may be indicated to the boiler operator. If the risk level exceeds a preset limit, the exceeding is indicated to the boiler operator, the boiler operator is alarmed, and/or the boiler shutdown is automatically suggested or initiated.

In the leakage detection method according to the second aspect of the present invention, a risk level is computed using a time series of measures between model-based quantities estimated for the actual bed situation using determined fluidized bed combustion boiler operating parameters and the respective quantities computed from measurements, such that measures are evaluated in at least two overlapping time windows having different lengths, wherein the narrower time window requires in proportion a higher number of measures exceeding a threshold value than the broader time window. The risk level may be indicated to the boiler operator. If the risk level exceeds a preset limit, the exceeding is indicated to the boiler operator, the boiler operator is alarmed, and/or the boiler shutdown is automatically suggested or initiated.

In the leakage detection method according to the third aspect of the present invention, a risk level is computed using a time series of measures between model-based quantities estimated for the actual bed situation using determined fluidized bed combustion boiler operating parameters and the respective quantities computed from measurements, such that the model-based quantities are estimated using calibrated values, and wherein the calibrated values are obtained by analyzing as training data historical data that from further in the past than the time series used in risk level computation. The risk level may be indicated to the boiler operator. If the risk level exceeds a preset limit, the exceeding is indicated to the boiler operator, the boiler operator is alarmed, and/or the boiler shutdown is automatically suggested or initiated.

The model-based quantities estimated for the actual bed situation using determined fluidized bed combustion boiler operating parameters and the respective quantities computed from measurements preferably include one or more of the following: water-steam balance, flue gas exit temperature, bed temperature, pressure, such that advantageously water-steam balance is used.

The risk level is preferably computed as a weighted sum of any different measures, optionally requiring for each measure the exceeding of a specific threshold value for it to be included in the computation. The risk level may further be computed so that when risk level exceeds 100% it is displayed only as 100%.

The differences between model-based quantities and the respective quantities computed from measurements may be rather large. These result from the fact that combustion conditions are under continuous change, and that there are certain fluctuations taking place all the time in a combustion boiler. For a combustion boiler producing superheated steam in the rate of 400 kg/s, the steam flow may in practice fluctuate between 5 to 10 kg/s up and down.

The finding behind the first aspect of the invention is that, while given the rather large fluctuations in the model-based quantities and the respective quantities computed from measurement certain make with a high probability smaller measures very frequent in the time series analysis, it is not very probable that larger measures would be present a number of times in the time series analysis without a good cause. Thus, a larger tube leakage in a combustion boiler can be detected considerably faster than in the background art (Modern Power Systems December 2018 article), if a number of threshold values exceeding in a time window measures accounts to the risk level proportionally to the sum of measures magnitude overproportional manner respective to exceeding a threshold value to their magnitude. As an example, we refer to the results in the Modern Power Systems article in Ill. 6 on p. 38. The applicant's former method was able to detect leakage in a furnace wall after about thirty minutes (second arrow from the left) from the start of the leakage (first arrow from the left). With the present method, the inventors have been able to reliably detect the same leakage in about two to four minutes based on the same data.

The finding behind the second aspect of the invention is that, while given the rather large fluctuations in the model-based quantities and the respective quantities computed from measurement certain make with a high probability smaller measures very frequent in the time series analysis, it is not very probable that smaller measures would be present for a longer period of time without a good cause. Thus, a smaller tube leakage in a combustion boiler can be detected considerably more reliably than in the background art (Modern Power Systems December 2018 article), if the measures are evaluated in at least two overlapping time windows having different lengths, such that the narrower time window will require in proportion to the time window length a higher number of small measures exceeding a threshold value than the broader time window. With the present method, the inventors have been able to more frequently rule out suspected tube leaks as non-leaks also in situations that would, with the background art method, have led to a false leakage alarm.

The finding behind the third aspect is that the rather large fluctuations in the model-based quantities and the respective quantities computed from measurement may have some time shifting characteristics in the time series analysis. If there is time shifting, the computation of the estimates with the numerical model gives inaccurate results that may not be reliable anymore. In this situation, since the model-based quantities are estimated using a calibrated mathematical model using coefficient values obtained using numerical fitting, the effect of the time shifting characteristics can be suppressed or even ruled out if the calibrated values are obtained by analyzing as numerical fitting is repeated on training data historical data from further in the past than the time series used in the present risk level computation. Preferably, the historical data is from at least a few days ago, even better from a week or even two weeks ago. With this method, slowly developing tube leaks can be detected more reliably than with the method in the background art (Modern Power Systems December 2018 article).

In the tube leakage detection method according to the fourth aspect of the present invention, a risk level is computed using a time series of measures between model-based quantities estimated for the actual bed situation using determined fluidized bed combustion boiler operating parameters and the respective quantities computed from measurements, including at least one but, preferably, all of the following: at least one separator, at least one solids return chamber heat exchanger, at least one loop seal. The risk level may be indicated to the boiler operator. If the risk level exceeds a preset limit, the exceeding is indicated to the boiler operator, the boiler operator is alarmed, and/or the boiler shutdown is automatically suggested or initiated.

The finding behind the fourth aspect is that, in fluidized bed boilers, a tube leakage can generally cause an effect comparable with sandblasting, where abrasive bed material is pressed by high pressure steam or water against a boiler structure, such as another tube. Thus, CFB boiler leakage detection that is carried out for at least one separator, at least one solids return chamber heat exchanger FBHE, and/or at least one loop seal can help to reduce damage in these parts of the boiler.

Even though a tube leakage does not necessarily have very bad consequences in the furnace if the furnace wall water tube is leaking, the situation will be drastically different in certain CFB boiler structures (separator, solids return chamber heat exchanger, loop seal) where heat exchanger tubes are relatively close to each other. In the solids return chamber heat exchanger, for example, the separation of neighboring heat exchanger tubes may be only ten cm, a tube leakage in such a component with further a high bed material density may cause a rapid worsening of the leakage by the increasing abrasive effect of bed material due to the leakage. In the lower part of a CFB furnace, for example, the bed material density may be in the range of some dozens kg/m³, while, in the solids return chamber heat exchanger, the bed material density may be in the range of 1000 to 1500 kg/m³. Further, a leak in a furnace tube wall does not generally damage neighboring tubes since the neighboring tubes will not be in the direction of the bed material blasting caused by the leakage.

In a corresponding way, the invention and its aspects can be utilized for determining leakage in various reactors and processes where heat transfer fluid carries heat and heat transfer surfaces receive or extract heat between the process and the heat transfer fluid. Suitable processes and reactors are: a thermochemical reactor, a gasifier, an autothermal reactor, in connection with CO₂ capture, in processes converting waste material into reusable products, where heat generation and its recovery is involved.

It is obvious to the skilled person that, along with the technical progress, the basic idea of the invention can be implemented in many ways. The invention and its embodiments are thus not limited to the examples and samples described above but they may vary within the contents of the patent claims and their legal equivalents.

In the claims that follow and in the preceding description of the invention, except where the context requires otherwise due to express language or necessary implication, the word “comprise” or variations such as “comprises” or “comprising” is used in an inclusive sense, i.e. to specify the presence of the stated feature but not to preclude the presence or addition of further features in various embodiments of the invention.

1.-13. (canceled)

14. A method of determining a leakage in a heat transfer fluid channel of a heat transferring reactor system, the method comprising the steps of:
measuring the heat transfer fluid flow rate (q_{MS,M}) prevailing in the heat transfer heat transfer fluid channel of the reactor system during operation;
modelling heat transfer heat transfer fluid flow rate (q_{MS,C}) in the heat transfer heat transfer fluid channel during operation by utilizing process data in a numerical model of the heat transferring reactor system giving the heat transfer fluid (q_{MS,C}) flow rate of the heat transferring reactor system under substantially leak-free conditions;
comparing the measured heat transfer fluid flow rate in the heat transfer fluid channel and modelled heat transfer fluid flow rate with each other to obtain an error measure (D_{MS}) for heat transfer fluid flow rate that is included in an error measure set;
monitoring the error measure set and a number of occurrences in the error measure set during operation; and
determining the presence of a heat transfer fluid channel leakage in case the error measures (D_{MS}) exceed a pre-defined threshold, or a number of occurrences in the error measure set exceed a predetermined threshold during a predetermined time period.

15. The method according to claim 14, further comprising the steps of:
measuring at least one process parameter prevailing in at least one location inside a reaction chamber of the reactor system;
modelling at least one of corresponding process parameters during operation of the heat transferring reactor system by utilizing process data in a numerical model, giving the corresponding process parameter of the heat transferring reactor system under substantially leak-free conditions; and
comparing the at least one measured process parameter and the corresponding at least one modelled process parameter with each other to obtain an error measure for the at least one process parameters also included in the error measure set.

16. The method according to claim 15, wherein the at least one process parameter comprises at least one of temperature and pressure.

17. The method according to claim 15, wherein the heat transferring reactor system is a fluidized bed reactor system.

18. The method according to claim 17, wherein the at least one process parameter includes a pressure in a loop seal arranged downstream of a particle separator in a return leg, which return leg is arranged for returning separated particles into the reaction chamber.

19. The method according to claim 18, further comprising:
monitoring a number of occurrences of error measure for the heat transfer heat transfer fluid flow rate exceeds predetermined threshold, wherein the number of occurrences in exceedances is included in the characteristics of error measure;
monitoring a number of occurrences of error measure for pressure (p_{w,i}) in the loop seal (200) exceeds a predetermined threshold, which the number of occurrences in exceedances is included in the characteristics of error measure; and
determining a heat transfer heat transfer fluid channel leakage is determined to be in the loop seal if the error measure for main heat transfer heat transfer fluid flow and the number of occurrences of error measure for main heat transfer heat transfer fluid flow rate exceed the predetermined threshold, and further if: an error measure related to pressure in the loop seal and the number of occurrences of pressure in the loop seal parameters in the loop seal exceed the predetermined threshold.

20. The method according to claim 17, wherein the at least one process parameter includes a product gas temperature (T_{se,i}) at an exit of a particle separator.

21. The method according to claim 20, wherein a leakage is determined to be in the particle separator if the error measure for main heat transfer heat transfer fluid flow and the number of occurrences of error measure for main heat transfer heat transfer fluid flow both exceed, respectively, the predetermined threshold for corresponding error measures and, further,
if an error measure related to product gas temperature at the exit of the particle separator and the number of occurrences of product gas temperature at the exit of particle separator both exceed, respectively, a predetermined threshold for the product gas temperature error measures.

22. A method according to claim 17, wherein the at least one process parameter includes bed temperature in a heat transfer fluidized bed heat exchanger.

23. The method according to claim 22, wherein a heat transfer fluid channel leakage is determined at the heat transfer fluidized bed heat exchanger if an error measure of bed temperature of the heat transfer fluidized bed heat exchanger and the number of occurrences of error measure both exceed, respectively, a predetermined threshold.

24. The method according to claim 14, wherein the characteristics of error measure include the number of respective occurrences exceeding a predetermined threshold.

25. A heat transferring reactor system comprising:
a heat transferring reactor system comprising a control system, which is configured to carry out the method according to claim 14.

26. A heat transferring reactor system according to claim 25, wherein the heat transferring reactor system comprises a display/monitor for displaying, to an operator, the presence of flow channel leakage detected using the method.
